(19) United States
(12) Patent Application Publication
(10) Pub. No.: US 2012/0065357 A1
(43) Pub. Date: Mar. 15, 2012

(54) RESIN FOR USE IN TONER, AND TONER AND DEVELOPER USING THE RESIN

(76) Inventors: Yoshitaka YAMAUCHI, Shizuoka (JP); Taichi Nemoto, Shizuoka (JP); Daisuke Asahina, Shizuoka (JP); Susumu Chiba, Shizuoka (JP); Chiaki Tanaka, Shizuoka (JP)

(21) Appl. No.: 13/206,876

(22) Filed: Aug. 10, 2011

(30) Foreign Application Priority Data
Sep. 15, 2010 (JP) 2010-206249

(51) Int. Cl. G03G 9/087; C08G 63/60; C08G 63/08; C08G 63/06

(52) U.S. Cl. 528/302; 528/361; 528/354

(57) ABSTRACT

A resin for use in toner including a polyhydroxycarboxylic acid skeleton in an amount of 50 to 80% by mass. The resin is soluble in organic solvents and has a glass transition temperature of 60° C. or more.

### CROSS-REFERENCE TO RELATED APPLICATIONS

The present patent application claims priority pursuant to 35 U.S.C. §119 from Japanese Patent Application No. 2010-206249, filed on Sep. 15, 2010, which is hereby incorporated by reference herein in its entirety.

### BACKGROUND

1. Field of the Invention

The present invention relates to a resin for use in toner used for electrophotographic image formation, such as copier, electrostatic printing, printer, facsimile machine, and electrostatic recording. In addition, the present invention also relates to a toner and a developer using the resin.

2. Description of the Background

Binder resin generally occupies 70% or more of toner constituents. Most binder resins are derived from petroleum resources now being exposed to depletion. Petroleum resources cause a problem of global warming because they discharge carbon dioxide into the air when consumed. On the other hand, binder resins derived from plant resources have been proposed and used for toners. Because plant resources have incorporated carbon dioxide from the air in the process of growing, carbon dioxide discharged from plant resources is merely circulated between the air and plant resources. Thus, plant resources have the potential to solve the problems of both depletion and global warming. For example, binder resins derived from polylactic acids have been proposed.

Polylactic acids consisting of L-form or D-form have high crystallinity. Such polylactic acids are poorly soluble in organic solvents, and therefore they cannot be used for toners manufactured through a process in which binder resin is dissolved in organic solvents. In attempting to solve this problem, Japanese Patent Application Publication No. 2008-262179 proposes to mix L-form and D-form polylactic acids to reduce crystallinity to improve solubility in organic solvents. However, it is difficult to bring such polylactic acids into practical use because their glass transition temperatures are low, i.e., 60° C. or less, and the glass transition temperature and thermal deformation temperature are further decreased by moisture absorption. Therefore, toners using such polylactic acids or resultant image may conglutinate when transported or stored in high-temperature and high-humidity conditions.

Thus, polylactic acids need reformulation to be used as toner binder resin. Japanese Patent Application Publication No. 08-302003 describes a copolymerized polylactic acid obtained by reacting lactic acid with a reaction product of an aromatic dicarboxylic acid with an aliphatic diol. But this copolymerized polylactic acid still has a low glass transition temperature of 60° C. or less, which is not resistant to transportation or storage in high-temperature conditions. Japanese Patent Application Publication No. 2007-112849 describes a copolymerized polylactic acid having a fluorenone skeleton having a glass transition temperature of 60° C. or more. This copolymerized polylactic acid is not suitable for toner binder resin because fluorenone generally exhibits fluorescence under ultraviolet light.

Because of the above reasons, there is a need for a toner comprising a polylactic acid which has satisfactory heat-resistant and humidity-resistant storage stability and low-temperature fixability.

### SUMMARY

Exemplary aspects of the present invention are put forward in view of the above-described circumstances, and provide novel resin, toner, and developer each having heat-resistant and humidity-resistant storage stability and low-temperature fixability.

In one exemplary embodiment, a novel resin includes a polyhydroxycarboxylic acid skeleton in an amount of 50 to 80% by mass. The resin is soluble in organic solvents and has a glass transition temperature of 60° C. or more.

In another exemplary embodiment, a novel toner includes the above resin.

In yet another exemplary embodiment, a novel developer includes the above toner.

### DETAILED DESCRIPTION

Exemplary aspects of the present invention provide a resin for use in toner, which includes a polyhydroxycarboxylic acid skeleton in an amount of 50 to 80% by mass. The resin is soluble in organic solvents and has a glass transition temperature of 60° C. or more.

The resin preferably includes at least 50% by mass of the polyhydroxycarboxylic acid skeleton so that the resulting toner is fixable at low temperatures (hereinafter “low-temperature fixability”). When the mass content of the polyhydroxycarboxylic acid skeleton is too high, it is difficult to make the glass transition temperature be 60° C. or more because the polyhydroxycarboxylic acid skeleton has low thermal property even when the resin is reformed by introducing a later-described rigid moiety. Therefore, the resin preferably includes at most 80% by mass of the polyhydroxycarboxylic acid skeleton. When the glass transition temperature is less than 60° C., heat resistance may be poor.

The polyhydroxycarboxylic acid skeleton comprises a skeleton in which a single hydroxycarboxylic acid is polymerized or multiple hydroxycarboxylic acids are copolymerized, and can be obtained from hydrolysis condensation of hydroxycarboxylic acids or ring-opening polymerization of cyclic esters of the hydroxycarboxylic acids. Ring-opening polymerization of cyclic esters is more preferable because it can make the molecular weight of the resulting polyhydroxycarboxylic acid skeleton much greater. When a di- or more valent alcohol is used as an initiator in the polymerization, the resulting resin has an improved affinity for colorants. The polyhydroxycarboxylic acid skeleton is preferably formed from an aliphatic hydroxycarboxylic acid, more preferably a hydroxycarboxylic acid having 2 to 6 carbon atoms such as lactic acid, glycol acid, 3-hydroxybutyric acid, and 4-hydroxybutyric acid, to give transparency and good thermal property to the toner. Among these monomers, lactic acid is most preferable because the resulting resin has a proper glass transition temperature and improved transparency and affinity for colorants.

Other than the hydroxycarboxylic acids, cyclic esters of the hydroxycarboxylic acids are also usable as raw materials of the polyhydroxycarboxylic acid skeleton. In this case, the resulting skeleton has a configuration in which the hydroxycarboxylic acids constituting the cyclic esters are polymerized. For example, the polyhydroxycarboxylic acid skeleton obtained from lactic acid lactide has a configuration in which lactic acid is polymerized.

The resin preferably includes a rigid moiety that controls resin properties such as glass transition temperature. Preferably, the rigid moiety is a condensate of an aromatic dicarboxylic acid with an aliphatic diol.

Preferably, the rigid moiety has the following formula:

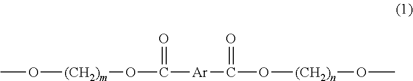

wherein each of m and n independently represents an integer of 2 to 10 and Ar represents an aromatic group.

The resin having the polyhydroxycarboxylic acid skeleton preferably includes the rigid moiety in an amount of 15% by mass or more so as to increase the glass transition temperature.

The rigid moiety has a hard segment including an aromatic group and ester bonds on its both terminals, and a flexible soft segment existing between one of the ester bond and a terminal hydroxyl group. The soft segment may be an alkyl chain. In the formula (1), the alkyl chain is represented by —(CH₂)m- or —(CH₂)n-. To give rigidity to the molecular chain, each of m and n preferably represents an integer of 2 to 10, more preferably 2 to 5, and most preferably 2 or 3.

Specific examples of compounds which may compose the rigid moiety include, but are not limited to, bis(2-hydroxyethyl) terephthalate (BHET) and bis(2-hydroxypropyl) terephthalate (BHPT).

Because the soft segment exists, it is likely that the rigid moieties interact with each other. On the other hand, when the rigid moiety has a portion that causes steric hindrance, the rigid moieties are prevented from interacting. For example, when the rigid moiety has a bisphenol A skeleton, steric hindrance may be notably caused.

Preferably, the resin includes the rigid moiety in an amount of 10 to 30% by mass, more preferably 15 to 30% by mass. When the amount of the rigid moiety is too small, heat-resistant storage stability of the resin may be poor because the resin (i.e., linear polyester resin) has a lower glass transition temperature compared to that of a linear polylactic resin. When the amount of the rigid moiety is too large, low-temperature fixability of the resin may be poor, not taking advantage of existence of the polylactic skeleton.

The resin having the polyhydroxycarboxylic acid skeleton has a glass transition temperature of 60° C. or more. Additionally, the resin preferably has a number average molecular weight of 7,000 to 30,000, more preferably 7,000 to 20,000. When the number average molecular weight is too large, the minimum fixable temperature of the resin may be too high, which is against energy saving. When the number average molecular weight is too small, the maximum fixable temperature of the resin may be too low.

The resin having the polyhydroxycarboxylic acid skeleton preferably has moisture resistance. When the resin absorbs moisture, glass transition temperature and thermal deformation temperature of the resin may decrease. Therefore, the resulting toners or images may conglutinate when transported or stored in high-temperature and high-humidity conditions.

The polyhydroxycarboxylic acid skeleton comprises a skeleton in which a single hydroxycarboxylic acid is polymerized or multiple hydroxycarboxylic acids are copolymerized, and can be obtained from hydrolysis condensation of hydroxycarboxylic acids or ring-opening polymerization of cyclic esters of hydroxycarboxylic acids. Ring-opening polymerization of cyclic esters is more preferable because it can make the molecular weight of the resulting polyhydroxycarboxylic acid skeleton much greater. The polyhydroxycarboxylic acid skeleton is preferably formed from an aliphatic hydroxycarboxylic acid, more preferably a hydroxycarboxylic acid having 2 to 6 carbon atoms, to give transparency and good thermal property to the toner. Among such optically-active monomers, lactic acid and lactide are preferable. Other than the hydroxycarboxylic acids, cyclic esters of the hydroxycarboxylic acids are also usable as raw materials of the polyhydroxycarboxylic acid skeleton. In this case, the resulting skeleton has a configuration in which the hydroxycarboxylic acids constituting the cyclic esters are polymerized. For example, the polyhydroxycarboxylic acid skeleton obtained from lactic acid lactide has a configuration in which lactic acids are polymerized.

The polyhydroxycarboxylic acid skeleton is preferably a polylactic acid skeleton. Polylactic acid is a polymer in which lactic acids are bonded with ester bonds. Polylactic acid is nowadays receiving attention as an environmentally-friendly biodegradable plastic. Because an enzyme which cuts ester bonds (i.e., esterase) exists in nature, polylactic acids are gradually decomposed into lactic acids by the enzyme, and the lactic acids are further decomposed into carbon dioxide and water.

The resin preferably has an optical purity X (%) of 80% or less, more preferably 60% or less. The optical purity X (%) is obtained from the following formula:

X (%)=|X(L-form)−X(D-form)|

wherein X(L-form) represents a ratio (%) of an L-form lactic acid monomer component and X(D-form) represents a ratio (%) of a D-form lactic acid monomer component.

The optical purity X can be measured as follows. First, an analyte, for example, a resin or toner having a polyester skeleton, is mixed with a mixture solvent of 1N pure water solution of sodium hydroxide and isopropyl alcohol and agitated at 70° C. to cause hydrolysis. The mixture is then filtered so that solid components are removed, and the filtrate is neutralized with sulfuric acid. Thus, an aqueous solution containing L-lactic acids and/or D-lactic acids which are decomposed from the polyester skeleton is obtained. The aqueous solution is then subjected to a measurement with a high-speed liquid chromatography (HPLC) equipped with chiral ligand exchangeable columns SUMICHIRAL OA-5000 (from Sumika Analysis Chemical Service, Ltd.). Peak areas S(L) and S(D) corresponding to L-lactic acid and D-lactic acid, respectively, are determined from the resulting chromatogram. The optical purity X is calculated from the peak areas as follows.

X(L-form) (%)=100×S(L)/(S(L)+S(D))

X(D-form) (%)=100×S(D)/(S(L)+S(D))

Optical purity X (%)=|X(L-form)−X(D-form)|

L-form and D-form are optical isomers. Optical isomers have the same physical and chemical properties other than optical properties. Because L-form and D-form have the same polymerization reactivity, the ratio between L-form and D-form monomers used for forming a polymer is equivalent to the ratio between L-form and D-form components in the resulting polymer.

When the optical purity is 80% or less, solvent solubility and transparency of the resin improve.

X(D-from) and X(L-form) are respectively equivalent to the ratios of D-form and L-form monomers used for forming the hydroxycarboxylic acid skeleton.

Polylactic resins can be obtained by known methods. For example, polylactic resins can be obtained from hydrolysis condensation of lactic acids obtained from fermentation of a starch (e.g., corn), or ring-opening polymerization of cyclic dimer lactides obtained from lactic acids in the presence of a catalyst. In particular, the ring-opening polymerization is more preferable in terms of manufacturability. The ring-opening polymerization can control molecular weight of the resin by controlling the amount of reaction initiator, and can be terminated within a short period.

As the reaction initiator, alcohols which do not volatilize even when dried at about 100° C. under a reduced pressure of 20 mmHg or less or when polymerized at a high temperature of about 200° C. are usable. The number of functional groups in the alcohols is not limited. Preferably, a diol-based rigid component, to be described in detail later, is used as the reaction initiator to be introduced into the polylactic acid skeleton.

The resin according to the present invention may be obtained by elongating such a rigid component or a polylactic acid including such a rigid component using an elongating agent. The elongating agent may be a compound having multiple functional groups reactive with hydroxyl group, such as isocyanate compounds, glycidyl compounds, acid anhydride compounds, and acid chloride compounds.

Specific examples of suitable elongating agents include, but are not limited to, diisocyanates (e.g., tolylene diisocyanate, tolidine diisocyanate, xylylene diisocyanate, diphenylmethane diisocyanate, naphthylene diisocyanate, isophorone diisocyanate, lysine diisocyanate, hexamethylene diisocyanate, methylenebis cyclohexyl diisocyanate), diglycidyl ethers (e.g., resorcinol diglycidyl ether, neopentyl glycol diglycidyl ether, hexanediol diglycidyl ether, hydrogenated bisphenol A diglycidyl ether, diglycidyl terephthalic acid, diglycidyl isophthalic acid, ethylene glycol diglycidyl ether, diethylene glycol diglycidyl ether, polyethylene glycol diglycidyl ether, polypropylene glycol diglycidyl ether), acid anhydrides (e.g., naphthalene tetracarboxylic acid anhydride, dioxotetrahydrofuranylmethyl cyclohexenedicarboxylic acid anhydride, pyromellitic anhydride, oxydiphthalic acid anhydride, biphenyl tetracarboxylic acid anhydride, benzophenone tetracarboxylic acid anhydride, diphenylsulfone tetracarboxylic acid anhydride, tetrafluoroisopropylidene diphthalic acid anhydride, terphenyl tetracarboxylic acid anhydride, cyclobutane tetracarboxylic acid anhydride, carboxymethylcyclopentane tricarboxylic acid anhydride), and aliphatic carboxylic acids (e.g., oxalic acid, malonic acid, succinic acid, glutaric acid, adipic acid, pimelic acid, suberic acid, azelaic acid, sebacic acid, cyclohexanedicarboxylic acid) and acid chlorides thereof. Among these compounds, diisocyanates are preferable because they have high reactivity and are easy to handle. Aromatic diisocyanates are more preferable because they have high reactivity and do not degrade glass transition temperature of the resultant resin. Specifically, isophorone diisocyanate (IPDI) is most preferable in terms of reactivity and safety.

To accelerate the reaction, esterification or urethanation catalysts, such as amine compounds, tin compounds, and titanium compounds, can be used. Because urethanation catalyst may also function as decomposition catalyst in resins, it is preferable to use urethanation catalyst as little as possible.

Various additives (e.g., thermal stabilizer, antioxidant, ultraviolet absorber, flame retardant, nonreactive hydrolysis inhibitor, light resistance improver, wax, lubricant, charge controlling agent, organic plasticizer, biodegradable thermoplastic resin, colorant, delustrant) may be added to the resin during and/or after the process of polymerization of the resin.

The toner according to exemplary aspects of the present invention may be obtained by either dry methods (e.g., kneading pulverization method) or wet methods (e.g., aggregation fusion method). Because polylactic acids are rigid and hard to be pulverized, they are preferably used for wet methods.

Some exemplary toner manufacturing methods (i.e., kneading pulverization method, emulsification aggregation method, dissolution suspension method, suspension granulation method, suspension polymerization method, ester elongation method) are described in detail below.

### 1) Kneading Pulverization Method

Kneading pulverization method includes the first premixing step, the second melt-kneading step, the third pulverization step, and the fourth classification step.

In the first premixing step, toner components such as a binder resin, a colorant, and a hydrophobized particle, are mixed under dry condition. The toner components may further include a release agent and a charge controlling agent, for example. The premixing may be preformed using a HENSCHEL-type mixer such as HENSCHEL MIXER (FM MIXER, from Nippon Coke and Engineering Co., Ltd.), SUPER MIXER (from KAWATA MFG Co., Ltd.), or MECHANOMILL (from Okada Seiko Co., Ltd.); HYBRIDIZATION SYSTEM (from Nara Machinery Co., Ltd.); or COSMO SYSTEM (from Kawasaki Heavy Industries, Ltd.).

In the second melt-kneading step, the mixture prepared in the first premixing step is melt-kneaded. The mixture is melt-kneaded at a temperature not less than the softening point and less than the thermal decomposition temperature of the binder resin so that toner components other than the binder resin are dispersed in the melted or softened binder resin.

The melt-kneading may be performed using a kneader such as a double-axis extruder, a two-roll mill, a three-roll mill, or a labo plastomill. More specifically, single-axis or double-axis extruders such as TEM-100B (from Toshiba Machine Co., Ltd.) and PCM-65/87 and PCM-30 (both from Ikegai Co., Ltd.); and open roll kneaders such as MOS320-1800 and KNEADEX (both from Nippon Coke and Engineering Co., Ltd.) are usable. The mixture may be kneaded using two or more of these kneaders.

In the third pulverization step, the melt-kneaded mixture prepared in the second melt-kneading step is solidified by cooling, and the solidified melt-kneaded mixture is further pulverized. First, the solidified melt-kneaded mixture is coarsely pulverized into coarse particles having a volume average particle diameter of about 100 μm to 5 mm by a hammer mill or a cutting mill. The coarse particles are further pulverized into fine particles having a volume average particle diameter of about 15 μm or less.

The fine pulverization may be performed by a jet-type pulverizer that uses supersonic jet air or an impact pulverizer that introduces samples into a space formed between a rotor rotating at a high speed and a stator. The solidified melt-kneaded mixture may be directly pulverized into fine particles by the jet-type pulverizer or impact pulverizer without going through coarse particles.

In the fourth classification step, the particles prepared in the third pulverization step are classified by size so that excessively-pulverized particles and oversized particles are removed. Such excessively-pulverized particles and oversized particles can be recycled for another toner manufacture. The classification may be performed by a swivel wind power classifier (rotary wind power classifier) that removes excessively-pulverized particles and oversized particles by centrifugal force and wind power. The classification condition is set so that toner particles having a volume average particle diameter of 3 to 15 μm are obtained.

### 2) Emulsification Aggregation Method

Emulsification aggregation method includes the first aggregation step, the second adhesion step, and the third fusion step.

In the first aggregation step, binder resin particles obtained by emulsion polymerization are dispersed in a solvent with an ionic surfactant. Other toner components, such as colorant, are dispersed in a solvent with another ionic surfactant having the opposite polarity. These dispersions are mixed to cause hetero aggregation. Thus, aggregated particles are formed.

In the second adhesion step, resin particles are optionally added and adhered to the surfaces of the aggregated particles so that a covering layer is formed on the aggregated particles. This process may make the resulting toner have a core-shell structure.

In the third fusion step, the aggregated particles having gone through the aggregation and the optional adhesion steps are fused with each other at or above the highest glass transition point or melting point of the binder resins. The fused particles are then washed and dried to obtain toner particles.

As described above, the second adhesion step is optional. In a case in which the adhesion step is employed, in the first aggregation step, initial amounts of ionic surfactants in each dispersions are made unbalanced. The ionic surfactants are then ionically neutralized with an inorganic metal salt (e.g., calcium nitrate) or an inorganic metal salt polymer (e.g., polyaluminum chloride) to form and stabilize aggregated particles (i.e., core particles) at or below the glass transition point or melting point. In the adhesion step, additional binder resin particles are added and adhered to the surface of the core particles. The additional binder resin particles have been treated with a specific amount of a dispersant having a specific polarity so that the unbalance among the dispersions is compensated. Optionally, the core particles adhering the additional binder resin particles are slightly heated at or below the glass transition point of the binder resin and stabilized at a higher temperature before being fused with each other.

The adhesion step can be repeated for several times.

### 3) Dissolution Suspension Method

Dissolution suspension method includes the steps of dissolving toner components such as a binder resin, a colorant, and a release agent in an organic solvent (e.g., ethyl acetate); and dispersing the resulting solution in an aqueous medium with an inorganic fine particle (e.g., calcium phosphate) or an organic dispersant (e.g., polyvinyl alcohol, sodium polyacrylate) upon application of mechanical shearing force by a homogenizer such as TK HOMOMIXER.

The resulting dispersion is added to 1M hydrochloric acid aqueous solution so that the dispersants are dissolved and removed, and is further filtered so that solid components and liquid components are separated. Finally, the solvents remaining in the resulting particles are removed. Thus, toner particles are obtained.

### 4) Dissolution Emulsification Method

Dissolution emulsification method includes the steps of dissolving a binder resin in an organic solvent (e.g., ethyl acetate); emulsifying the resulting solution by mechanical shearing force from a homogenizer such as TK HOMOMIXER and surface activating force of ionic surfactants (e.g., sodium alkylbenzene sulfonate) to form binder resin particles; and removing residual solvent by reduced-pressure distillation, to obtain a dispersion of the binder resin particles. Succeeding steps are the same as the emulsification aggregation method described above.

### 5) Suspension Granulation Method

Suspension granulation method includes the steps of preparing a polymer solution including a prepolymer having a weight average molecular weight (Mw) of 3,000 to 15,000 measured by GPC (gel permeation chromatography); adding toner components such as a colorant, a monomer, a polymerization initiator, and a release agent to the polymer solution; suspending the resulting solution upon application of mechanical shearing force in the presence of an inorganic or organic dispersant; and applying thermal energy to the resulting suspension upon application of agitation shearing force to prepare polymer particles.

When the prepolymer has a weight average molecular weight (Mw) of 3,000 to 15,000, the above solutions have a proper viscosity and the resulting toner has a proper fixing property. Additionally, the weight average molecular weight (Mw) of the binder resin included in the resultant toner is controllable without chain transfer agent.

### 6) Suspension Polymerization Method

Suspension polymerization method includes the steps of agitating a polymerizable mixture including a monomer, a polymerization initiator, a colorant, a release agent, etc. in an aqueous medium containing a suspension stabilizer, to prepare polymer particles. More preferably, suspension polymerization method includes the steps of agitating a polymerizable mixture including a monomer, a polymerization initiator, a colorant, a release agent, and a cationic polymer, in an aqueous medium containing an anionic dispersant, to prepare polymer particles. The resulting toner has a configuration such that the release agent is encapsulated in the suspending particle. Thus, this toner has improved fixability and offset resistance.

### 7) Ester Elongation Method

Ester elongation method includes the steps of preparing an oil phase by dispersing toner components such as a binder resin, a colorant, and a release agent in a solvent; preparing an aqueous phase by dispersing a particle diameter controlling agent and a surfactant in water; and emulsifying the oil phase in the aqueous phase. Thus, oil droplets each containing the binder resin, colorant, and release agent are formed. The oil droplets are further converged so that the particle size distribution is more narrowed. The binder resin is elongated in the process of emulsification so that a high-molecular-weight binder resin is formed in the oil droplets. Succeeding steps are the same as the dissolution suspension method described above.

The developer according to exemplary aspects of the invention includes the above-described toner and other components such as a carrier. The developer may be either a one-component developer or a two-component developer. The two-component developer is preferably used for high-speed printers which respond to recent improvement in information processing speed because of having a long lifespan.

The carrier preferably comprises a core material and a resin layer that covers the core material.

Specific preferred examples of suitable core materials include, but are not limited to, manganese-strontium (Mn—Sr) and manganese-magnesium (Mn—Mg) materials having a magnetization of 50 to 90 emu/g; and high magnetization materials such as iron powders having a magnetization of 100 emu/g or more and magnetites having a magnetization of 75 to 120 emu/g. The high magnetization materials are preferable in terms of high image density. Additionally, low magnetization materials such as copper-zinc (Cu—Zn) materials having a magnetization of 30 to 80 emu/g are preferable in terms of high image quality, because carriers made of such materials can weakly contact an electrostatic latent image bearing member. Two or more of these materials can be used in combination.

The core material preferably has a weight average particle diameter (D50) of 10 to 200 μm, and more preferably 40 to 100 μm. When D50 is too small, it means that the resulting carrier particles include a relatively large amount of fine particles and therefore the magnetization per carrier particle is too low to prevent the carrier particles from scattering. When D50 is too large, it means that the specific surface area of the carrier particle is too small to prevent toner particles from scattering. Therefore, solid portions in full-color images may not be reliably reproduced.

Specific preferred examples of suitable resins for the resin layer include, but are not limited to, amino resins, polyvinyl resins, polystyrene resins, halogenated olefin resins, polyester resins, polycarbonate resins, polyethylene resins, polyvinyl fluoride resins, polyvinylidene fluoride resins, poly(trifluoroethylene) resins, poly(hexafluoropropylene) resins, vinylidene fluoride-acrylic monomer copolymer, vinylidene fluoride-vinyl fluoride copolymer, tetrafluoroethylene-vinylidene fluoride-non-fluoride monomer terpolymer, and silicone resins. Two or more of these materials can be used in combination. Among these materials, silicone resins are preferable.

The silicone resin may be, for example, straight silicone resins consisting of organosiloxane bonds; or silicone resins modified with an alkyd resin, a polyester resin, an epoxy resin, an acrylic resin, or a urethane resin.

Specific examples of commercially available silicone resins include, but are not limited to, KR271, KR255, and KR152 (from Shin-Etsu Chemical Co., Ltd.); and SR2400, SR2406, and SR2410 (from Dow Corning Toray Co., Ltd.). Specific examples of commercially available modified silicone resins include, but are not limited to, KR206 (alkyd-modified), KR5208 (acrylic-modified), ES1001N (epoxy-modified), and KR305 (urethane-modified) (from Shin-Etsu Chemical Co., Ltd.); and SR2115 (epoxy-modified) and SR2110 (alkyd-modified) (from Dow Corning Toray Co., Ltd.).

Each of the silicone resins can be used alone or in combination with a cross-linking component or a charge controlling component.

The resin layer may include a conductive powder such as metal, carbon black, titanium oxide, tin oxide, and zinc oxide. The conductive powder preferably has an average particle diameter of 1 μm or less. When the average particle diameter is too large, it may be difficult to control electric resistivity of the resin layer.

The resin layer can be formed by, for example, dissolving the silicone resin in an organic solvent to prepare a coating liquid, and uniformly coating the coating liquid on the surface of the core material, followed by drying and baking. The coating method may be, for example, dip coating, spray coating, or brush coating.

Specific examples of usable organic solvents include, but are not limited to, toluene, xylene, methyl ethyl ketone, methyl isobutyl ketone, cellosolve, and butyl acetate.

The baking method may be either an external heating method or an internal heating method that uses a stationary electric furnace, a fluid electric furnace, a rotary electric furnace, a burner furnace, or microwave.

The carrier preferably includes the resin layer in an amount of 0.01 to 5.0% by weight. When the amount of the resin layer is too small, it means that the resin layer cannot be uniformly formed on the core material. When the amount of the resin layer is too large, it means that the resin layer is so thick the each carrier particles are fused with each other.

The ratio of the toner to 100 parts of the carrier in the two-component developer is preferably 1 to 10.0 parts by weight.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Various measurement procedures employed in the following Examples are described below.

### Measurement of Molecular Weight and Residual Monomer Quantity

Instrument: GPC (from Tosoh Corporation)

Detector: RI

Measuring temperature: 40° C.

Mobile phase: Tetrahydrofuran

Flow rate: 0.45 mL/min

Number average molecular weight (Mn), weight average molecular weight (Mw), and molecular weight distribution (Mw/Mn) were determined from a chromatogram measured by GPC (gel permeation chromatography) referring to a calibration curve complied from polystyrene standard samples having a known molecular weight.

### Measurement of 90% RH Thermal Deformation Temperature

Instrument: TMA (EXSTAR7000 from SII Nano Technology Inc.)

A die having a diameter of 3 mm and a thickness of 1 mm was filled with 5 to 10 mg of an analyte and the analyte was compressed by a hand-powered press. The analyte thus pelletized was heated from 30° C. to 90° C. at a heating rate of 2° C./min at 90% RH by a temperature/humidity controller attached to the instrument while a standard probe detected displacement by compressing the pellet at 100 mN. A maximum peak observed in the resulting thermogram was regarded as 90% RH thermal deformation temperature.

### Measurement of Glass Transition Temperature

Instrument: DSC (Q2000 from TA Instruments)

A simple sealed aluminum pan filled with 5 to 10 mg of an analyte was firstly heated from 30° C. to 220° C. at a heating rate of 5° C./min and kept at 220° C. for 1 minute; quenched to −20° C. without temperature control and kept at −20° C. for 1 minute; and secondly heated from −20° C. to 180° C. at a heating rate of 5° C./min. A value read from the thermogram resulted in the second heating using a midpoint method was regarded as glass transition temperature.

### Evaluation of Organic Solvent Solubility

An analyte (i.e., a resin) in an amount of 1.5 g was agitated with 8.5 g of each of ethyl acetate, tetrahydrofuran, and toluene in a 20-mL screw vial for 24 hours, and visually observed whether the analyte remain undissolved or not. When dissolved in all of the organic solvents, the analyte was regarded as having organic solvent solubility.

### Manufacturing Example 1

### Preparation of Resin A

A flask charged with 85.0 parts of L-lactide, 15.0 parts of D-lactide, and 9.3 parts of bis(2-hydroxyethyl) terephthalate (BHET) was gradually heated and subjected to dewatering under reduced pressure. The flask was further heated under N₂ purge. After visually checking that the reaction system became homogenized, 0.03 parts of tin 2-ethylhexanoate were added to cause polymerization, while the reaction system was controlled to have an inner temperature of 190° C. or less. After 2-hour reaction, the reaction system was switched to efflux system so that the unreacted lactides were removed under reduced pressure. Thus, the polymerization was terminated and a resin A was prepared.

### Manufacturing Examples 2 to 4

### Preparation of Resins B to D

The procedure for preparing the resin A in Manufacturing Example 1 was repeated except that the amounts of the L-lactide, D-lactide, and BHET were changed as described in Table 1. Thus, resins B to D were prepared.

TABLE 1

| Manufacturing | | L-Lactide | D-lactide | BHET |
|---|---|---|---|---|
| Example | Resin | (parts) | (parts) | (parts) |
| 1 | A | 85 | 15 | 9.3 |
| 2 | B | 90 | 10 | 9.3 |
| 3 | C | 90 | 10 | 4.6 |
| 4 | D | 95 | 5 | 9.3 |

### Manufacturing Example 5

### Preparation of Rigid Component A

A flask charged with 54 parts of terephthalic acid (i.e., dicarboxylic acid) and 46 parts of propylene glycol (i.e., diol) was heated to 260° C. under pressure to cause reaction while removing water from the reaction system.

### Manufacturing Examples 6 to 9

### Preparation of Rigid Components B to E

The procedure for preparing the rigid component A in Manufacturing Example 5 was repeated except that the amounts and kinds of the dicarboxylic acid and diol were changed as described in Table 2. Thus, rigid components B to E were prepared.

TABLE 2

| | | Dicarboxylic acid | | Diol | |
|---|---|---|---|---|---|
| Manufacturing | Rigid | | Amount | | Amount |
| Example | Component | Kind | (parts) | Kind | (parts) |
| 5 | A | Terephthalic acid | 53 | Propylene | 47 |
| | | | | glycol | |
| 6 | B | Terephthalic acid | 51 | 1,10- | 49 |
| | | | | Decanediol | |
| 7 | C | 2,6- | 56 | Ethylene | 44 |
| | | Naphthalenedicarboxylic | | glycol | |
| | | acid | | | |
| 8 | D | 4,4-biphenyldicarboxylic | 56 | Ethylene | 44 |
| | | acid | | glycol | |
| 9 | E | Terephthalic acid | 51 | EO adduct of | 49 |
| | | | | Bisphenol A | |

### Manufacturing Example 10

### Preparation of Resin 1

A flask charged with 88 parts of the resin A and 6 parts of bis(2-hydroxyethyl) terephthalate (BHET) was gradually heated. After visually checking that the reaction system became homogenized, the reaction system was subjected to dewatering under reduced pressure. The reaction system was further heated to 170° C. and 0.02 parts of tin 2-ethylhexanoate were added thereto. Further, 7 parts of isophorone diisocyanate (IPDI) serving as an elongating agent were added to the reaction system to cause elongation reaction. Thus, a resin 1 was prepared.

### Manufacturing Examples 11 to 14

### Preparation of Resins 2 to 5

The procedure for preparing the resin 1 in Manufacturing Example 10 was repeated except that the amounts and kinds of the rigid component, elongating agent, and pre-elongation polylactic resins were changed as described in Table 3. Thus, resins 2 to 5 were prepared.

### Manufacturing Examples 15 to 21

### Preparation of Resins 6 to 12

The procedure for preparing the resin 1 in Manufacturing Example 10 is repeated except that the amounts and kinds of the rigid component, elongating agent, and pre-elongation polylactic resins are changed as described in Table 3. Thus, resins 6 to 12 are prepared.

### Manufacturing Examples 22 to 25

### Preparation of Resins 13 to 16

The procedure for preparing the resin 1 in Manufacturing Example 10 was repeated except that the amounts and kinds of the rigid component, elongating agent, and pre-elongation polylactic resins were changed as described in Table 3. Thus, resins 13 to 16 were prepared.

TABLE 3

| Manu- | | | | | | | |
|---|---|---|---|---|---|---|---|
| fac- | | Rigid | | Elongating | | Pre-elongation | |
| turing | | Component | | Agent | | Polylactic Resin | |
| Exam- | | | Amount | | Amount | | Amount |
| ple | Resin | Kind | (parts) | Kind | (parts) | Kind | (parts) |
| 10 | 1 | BHET | 6 | IPDI | 7 | Resin A | 87 |
| 11 | 2 | BHET | 6 | IPDI | 7 | Resin B | 87 |
| 12 | 3 | BHET | 8 | IPDI | 9 | Resin C | 83 |
| 13 | 4 | BHET | 16 | IPDI | 18 | Resin B | 66 |
| 14 | 5 | BHET | 21 | IPDI | 23 | Resin B | 56 |
| 15 | 6 | BHET | 9 | HDI | 14 | Resin B | 79 |
| 16 | 7 | BHET | 9 | EGDE | 15 | Resin B | 78 |
| 17 | 8 | BHET | 9 | BTCA | 15 | Resin B | 78 |
| 18 | 9 | Rigid | 9 | IPDI | 13 | Resin B | 79 |
| | | Com- | | | | | |
| | | ponent | | | | | |
| | | A | | | | | |
| 19 | 10 | Rigid | 9 | IPDI | 12 | Resin B | 79 |
| | | Com- | | | | | |
| | | ponent | | | | | |
| | | B | | | | | |
| 20 | 11 | Rigid | 9 | IPDI | 12 | Resin B | 79 |
| | | Com- | | | | | |
| | | ponent | | | | | |
| | | C | | | | | |
| 21 | 12 | Rigid | 9 | IPDI | 12 | Resin B | 79 |
| | | Com- | | | | | |
| | | ponent | | | | | |
| | | D | | | | | |
| 22 | 13 | BHET | 9 | IPDI | 14 | Resin D | 79 |
| 23 | 14 | BHET | 2 | IPDI | 4 | Resin B | 94 |
| 24 | 15 | — | — | IPDI | 7 | Resin B | 93 |
| 25 | 16 | Rigid | 9 | IPDI | 12 | Resin B | 79 |
| | | Com- | | | | | |
| | | ponent | | | | | |
| | | E | | | | | |

In Table 3, BHET represents bis(2-hydroxyethyl) terephthalate, IPDI represents isophorone diisocyanate, HDI represents hexamethylene diisocyanate, EGDE represents ethylene glycol diglycidyl ether, and BTCA represents pyromellitic anhydride.

### Manufacturing Example 26

### Preparation of Resin 17

The procedure for preparing the resin A in Manufacturing Example 1 was repeated except that the bis(2-hydroxyethyl) terephthalate was replaced with 1.6 parts of lauryl alcohol. Thus, a resin 17 was prepared.

Properties of the resins 1 to 17 are shown in Table 4.

TABLE 4

| | Polylactic Acid Resin Properties | | | | | |
|---|---|---|---|---|---|---|
| | Content of | Content of | | | 90% RH | |
| | Polyhydroxy- | Rigid | Number | Glass | Thermal | |
| | carboxylic | Moiety | Average | Transition | Deformation | Organic |
| | Acid Skeleton | (% by | Molecular | Temperature | Temperature | Solvent |
| Resin | (% by mass) | mass) | Weight | (° C.) | (° C.) | Solubility |
| 1 | 79.6 | 13 | 21,000 | 63 | 53 | Yes |
| 2 | 79.6 | 13 | 21,000 | 64 | 54 | Yes |
| 3 | 79.3 | 12 | 28,000 | 62 | 54 | Yes |
| 4 | 60.4 | 23 | 14,000 | 66 | 53 | Yes |
| 5 | 51.2 | 26 | 20,000 | 68 | 55 | Yes |
| 6 | 72.3 | 17 | 18,000 | 64 | 57 | Yes |
| 7 | 71.4 | 17 | 18,000 | 65 | 53 | Yes |
| 8 | 71.4 | 17 | 18,000 | 65 | 53 | Yes |
| 9 | 72.3 | 17 | 18,000 | 65 | 53 | Yes |
| 10 | 72.3 | 17 | 18,000 | 64 | 53 | Yes |
| 11 | 72.3 | 17 | 18,000 | 65 | 53 | Yes |
| 12 | 72.3 | 17 | 18,000 | 64 | 53 | Yes |
| 13 | 72.3 | 11 | 19,000 | 58 | 52 | No |
| 14 | 86.0 | 9 | 33,000 | 58 | 49 | Yes |
| 15 | 85.1 | 17 | 40,000 | 55 | 46 | Yes |
| 16 | 72.3 | 17 | 19,000 | 57 | 48 | Yes |
| 17 | 72.3 | 0 | 22,000 | 47 | 46 | Yes |

In Table 4, “Content of Rigid Moiety” represents total amount of the rigid moieties included in the pre-elongation polylactic acids (i.e., resins A to D) and the additional rigid components.

### Example 1

### Preparation of Toner 1

### Preparation of Master Batch

Raw materials described in Table 5 were mixed by a HENSCHEL MIXER to prepare a pigment aggregation into which water penetrates. The pigment aggregation was then kneaded by double rolls having a surface temperature of 130° C. for 45 minutes, and then pulverized into particles having a diameter of 1 mm by a pulverizer. Thus, a master batch was prepared.

TABLE 5
Master Batch Composition

| | |
|---|---|
| C. I. Pigment Yellow 185 | 40 parts |
| Resin 1 | 60 parts |
| Water | 30 parts |

Raw materials described in Table 6 were kneaded by a double-axis extruder at 100° C., followed by pulverization and classification, to prepare mother toner particles. The carnauba wax had a molecular weight of 1,800, an acid value of 2.7 mgKOH/g, and a penetration of 1.7 mm (40° C.). The charge controlling agent was E-84 from Orient Chemical Industries Co., Ltd. The mother toner particles in an amount of 100 parts were mixed with 0.5 parts of a hydrophobized silica and 0.5 parts of a hydrophobized titanium oxide by a HENSCHEL MIXER. Thus, a toner 1 was prepared.

TABLE 6
Toner 1 Composition

| | |
|---|---|
| Resin 1 | 90 parts |
| Carnauba wax | 4 parts |
| Master batch | 5 parts |
| Charge controlling agent | 1 part |

### Examples 2 to 5

### Preparation of Toners 2 to 5

The procedure for preparing the toner 1 in Example 1 was repeated except that the resin was changed as described in Table 7. Thus, toners 2 to 5 were prepared.

### Examples 6 to 12

### Preparation of Toners 6 to 12

The procedure for preparing the toner 1 in Example 1 is repeated except that the resin is changed as described in Table 7. Thus, toners 6 to 12 were prepared.

### Example 13

### Preparation of Toner 13

The procedure for preparing the toner 1 in Example 1 was repeated except that the resin was changed as described in Table 7. Thus, toner 13 was prepared.

### Example 14

### Preparation of Toner 14

### Preparation of Resin Particle Dispersion

A stainless-steel beaker was charged with 180 parts of the resin 4 and 585 parts of deionized water, and heated to 95° C. in a hot bath. Upon melting of the resin 4, the mixture was agitated by a homogenizer (ULTRA-TURRAX T50 from IKA) at 8,000 rpm and controlled to have a pH of 7.0 by adding diluted ammonia water. Next, 20 parts of an aqueous solution in which 0.8 parts of an anionic surfactant (NEOGEN R from Dai-ichi Kogyo Seiyaku Co., Ltd.) wre dissolved were dropped therein to cause emulsification. Thus, a resin particle dispersion including 12.4% of resin particles was prepared.

### Preparation of Black Colorant Dispersion

First, 99 parts of a carbon black (REGAL 330 from Cabot Corporation), 15 parts of an anionic surfactant (NEOGEN R from Dai-ichi Kogyo Seiyaku Co., Ltd.), and 300 parts of ion-exchange water were mixed. The mixture was subjected to a dispersion treatment by a homogenizer (ULTRA-TURRAX T50 from IKA) for 10 minutes and an ultrasonic dispersion treatment by a circulating ultrasonic disperser (RUS-600TCVP from NISSEI Corporation). Thus, a black colorant dispersion was prepared. Preparation of Release Agent Dispersion

First, 100 parts of a Fischer-Tropsch wax (FNP92 from Nippon Seiro Co., Ltd.) having a melting point of 92° C., 3.6 parts of an anionic surfactant (NEOGEN R from Dai-ichi Kogyo Seiyaku Co., Ltd.), and 400 parts of ion-exchange water were mixed. The mixture was heated to 100° C. and subjected to a dispersion treatment by a homogenizer (ULTRA-TURRAX T50 from IKA) for 10 minutes and another dispersion treatment by a pressure discharge gaulin homogenizer. Thus, a release agent dispersion was prepared.

### Preparation of Toner

First, 105 parts of the resin particle dispersion, 45 parts of the black colorant dispersion, 115 parts of the release agent dispersion, and 402 parts of deionized water were mixed in a stainless-steel round flask and dispersed by a homogenizer (ULTRA-TURRAX T50 from IKA). Next, 0.37 parts of polyaluminum chloride were added to the mixture and dispersed by the homogenizer (ULTRA-TURRAX T50 from IKA).

The flask was heated to 52° C. in an oil bath while agitating the mixture. The mixture was then controlled to have a pH of 8.5 by adding a 0.5N aqueous solution of sodium hydroxide. The flask was sealed and heated to 90° C. for 3 hours while agitating the mixture by magnetic force.

After termination of the reaction, the mixture was subjected to cooling, filtration, washing with ion-exchange water, and solid-liquid separation by nutsche suction filtration.

The solid components were redispersed in 3 liters of ion-exchange water at 40° C. and agitated for 15 minutes at 300 rpm to be washed. This operation was repeated 5 times. When the filtrate became to have a pH of 7.00, an electric conductivity of 8.7 μS/cm, and a surface tension of 7.08 Nm, solid-liquid separation was performed by nutsche suction filtration using a filter paper No. 5A, followed by 12 hours of vacuum drying. Thus, mother toner particles 14 were prepared.

The mother toner particles 14 in an amount of 100 parts were mixed with 1.5 parts of a hydrophobized silica (TS720 from Cabot Corporation) by a HENSCHEL MIXER for 5 minutes at 3,000 rpm. Thus, a toner 14 was prepared.

### Example 15

### Preparation of Toner 15

The procedure for preparing the toner 14 in Example 14 was repeated except that the resin 4 was replaced with the resin 5. Thus, toner 15 was prepared.

### Example 16

### Preparation of Toner 16

The procedure for preparing the toner 14 in Example 14 is repeated except that the resin 4 is replaced with the resin 6. Thus, toner 16 was prepared.

### Example 17

### Preparation of Toner 17

### Preparation of Aqueous Medium (a)

An aqueous medium (a) was prepared by mixing and agitating 300 parts of ion-exchange water and 0.2 parts of sodium dodecylbenzenesulfonate.

### Preparation of Master Batch (a)

First, 1,000 parts of water, 530 parts of a carbon black having a DBP oil absorption of 42 ml/100 g and a pH of 9.5 (PRINTEX 35 from Degussa), and 1,200 parts of a resin were mixed using a HENSCHEL MIXER (from Mitsui Mining and Smelting Co., Ltd.). The resulting mixture was kneaded for 30 minutes at 150° C. using double rolls, the kneaded mixture was then rolled and cooled, and the rolled mixture was then pulverized into particles using a pulverizer. Thus, a master batch (a) was prepared.

### Preparation of Toner

A resin solution 17 was prepared by mixing and agitating 100 parts of the resin 4 and 50 parts of ethyl acetate in a reaction vessel.

Further, 5 parts of a carnauba wax (having a molecular weight of 1,800, an acid value of 2.7 mgKOH/g, and a penetration of 1.7 mm (at 40° C.)) and 5 parts of the master batch (a) were added to the resin solution 17. The resulting mixture was then subjected to a dispersion treatment using a bead mill (ULTRAVISCOMILL (trademark) from Aimex Co., Ltd.) filled with 80% by volume of zirconia beads having a diameter of 0.5 mm, at a liquid feeding speed of 1 kg/hour and a disc peripheral speed of 6 m/sec. This dispersing operation was repeated 3 times (3 passes).

While agitating 150 parts of the aqueous medium (a) in a vessel at a revolution of 12,000 rpm using a TK HOMOMIXER (from PRIMIX Corporation), 100 parts of the above-prepared toner components liquid were added and mixed for 10 minutes. Thus, an emulsion slurry was prepared.

A flask equipped with a stirrer and a thermometer was charged with 100 parts of the emulsion slurry. The emulsion slurry was agitated for 10 hours at 30° C. at a peripheral speed of 20 m/min so that the organic solvents were removed therefrom. Thus, a dispersion slurry (a) was prepared.

Next, 100 parts of the dispersion slurry (a) was filtered under reduced pressures to obtain a wet cake (i). The wet cake (i) was then mixed with 100 parts of ion-exchange water using a TK HOMOMIXER for 10 minutes at a revolution of 12,000 rpm, followed by filtration, thus obtaining a wet cake (ii).

The wet cake (ii) was mixed with 300 parts of ion-exchange water using a TK HOMOMIXER for 10 minutes at a revolution of 12,000 rpm, followed by filtration. This operation was repeated twice, thus obtaining a wet cake (iii). The wet cake (iii) was mixed with 20 parts of a 10% aqueous solution of sodium hydroxide using a TK HOMOMIXER for 30 minutes at a revolution of 12,000 rpm, followed by filtration under reduced pressures, thus obtaining a wet cake (iv). The wet cake (iv) was mixed with 300 parts of ion-exchange water using a TK HOMOMIXER for 10 minutes at a revolution of 12,000 rpm, followed by filtration, thus obtaining a wet cake (v). The wet cake (v) was mixed with 300 parts of ion-exchange water using a TK HOMOMIXER for 10 minutes at a revolution of 12,000 rpm, followed by filtration. This operation was repeated twice, thus obtaining a wet cake (vi). The wet cake (vi) was mixed with 20 parts of a 10% hydrochloric acid using a TK HOMOMIXER for 10 minutes at a revolution of 12,000 rpm. Thereafter, a 5% methanol solution of a fluorine-containing quaternary ammonium salt (FTERGENT F-310 from Neos Company Limited) was added so that the resulting mixture was including 0.1 parts of the fluorine-containing quaternary ammonium salt based on 100 parts of the solid components. The mixture was further agitated for 10 minutes, followed by filtration, thus obtaining a wet cake (vii). The wet cake (vii) was mixed with 300 parts of ion-exchange water using a TK HOMOMIXER for 10 minutes at a revolution of 12,000 rpm, followed by filtration. This operation was repeated twice, thus obtaining a wet cake (viii).

The wet cake (viii) was dried by a circulating drier for 36 hours at 40° C., and filtered with a mesh having openings of 75 μm. Thus, mother toner particles 17 were prepared. The succeeding procedures were the same as Example 14. Thus, a toner 17 was prepared.

### Example 18

### Preparation of Toner 18

The procedure for preparing the toner 17 in Example 17 was repeated except that the resin 4 was replaced with the resin 5. Thus, toner 18 was prepared.

### Example 19

### Preparation of Toner 19

The procedure for preparing the toner 17 in Example 17 was repeated except that the resin 4 was replaced with the resin 6. Thus, toner 19 was prepared.

### Comparative Examples 1 to 4

### Preparation of Toners 23 to 26

The procedure for preparing the toner 17 in Example 17 was repeated except that the resin 4 was replaced with each of the resins 14 to 17. Thus, toners 23 to 26 were prepared.

### Example 20

### Preparation of Toner 20

### Preparation of Resin Particle Dispersion W

Preparation of Toner 20A reaction vessel equipped with a stirrer and a thermometer was charged with 600 parts of water, 120 parts of styrene, 100 parts of methacrylic acid, 45 parts of butyl acrylate, 10 parts of a sodium alkylallylsulfosuccinate (ELEMINOL JS-2 from Sanyo Chemical Industries, Ltd.), and 1 part of ammonium persulfate. The mixture was agitated for 20 minutes at a revolution of 400 rpm. Thus, a white emulsion was prepared.

The white emulsion was heated to 75° C. and subjected to reaction for 6 hours. A 1% aqueous solution of ammonium persulfate in an amount of 30 parts was further added to the emulsion, and the mixture was aged for 6 hours at 75° C. Thus, a resin particle dispersion W being an aqueous dispersion of a vinyl resin (i.e., a copolymer of styrene, methacrylic acid, butyl acrylate, and sodium alkylallylsulfosuccinate) was prepared.

The resin particles dispersed in the resin particle dispersion W had a volume average particle diameter of 0.08 μm measured by ELS-800.

The dried resin particles separated from the resin particle dispersion W had a glass transition temperature of 74° C. measured by a flow tester.

### Preparation of Aqueous Medium (b)

An aqueous medium (b) was prepared by mixing and agitating 300 parts of ion-exchange water, 300 parts of the resin particle dispersion W, and 0.2 parts of sodium dodecylbenzenesulfonate.

### Preparation of Polyester Prepolymer

A reaction vessel equipped with a condenser, a stirrer, and a nitrogen inlet pipe was charged with 720 parts of ethylene oxide 2 mol adduct of bisphenol A, 90 parts of propylene oxide 2 mol adduct of bisphenol A, 290 parts of terephthalic acid, 25 parts of trimellitic anhydride, and 2 parts of dibutyltin oxide. The mixture was subjected to reaction for 8 hours at 230° C. under normal pressures and subsequent 7 hours under reduced pressures of 10 to 15 mmHg. Thus, an intermediate polyester resin was prepared.

The intermediate polyester had a number average molecular weight (Mn) of 2,500, a weight average molecular weight (Mw) of 10,700, a peak molecular weight of 3,400, a glass transition temperature (Tg) of 57° C., an acid value of 0.4 mgKOH/g, and a hydroxyl value of 49 mgKOH/g.

Another reaction vessel equipped with a condenser, a stirrer, and a nitrogen inlet pipe was charged with 400 parts of the intermediate polyester resin, 95 parts of isophorone diisocyanate, and 580 parts of ethyl acetate. The mixture was subjected to reaction for 8 hours at 100° C. Thus, a polyester prepolymer was prepared. The polyester prepolymer was including 1.42% of free isocyanates.

### Preparation of Master Batch (b)

First, 1,000 parts of water, 530 parts of a carbon black having a DBP oil absorption of 42 ml/100 g and a pH of 9.5 (PRINTEX 35 from Degussa), and 1,200 parts of a resin were mixed using a HENSCHEL MIXER (from Mitsui Mining and Smelting Co., Ltd.). The resulting mixture was kneaded for 30 minutes at 150° C. using double rolls, the kneaded mixture was then rolled and cooled, and the rolled mixture was then pulverized into particles using a pulverizer. Thus, a master batch (b) was prepared.

### Preparation of Ketimine Compound

A reaction vessel equipped with a stirrer and a thermometer was charged with 30 parts of isophoronediamine and 70 parts of methyl ethyl ketone. The mixture was subjected to reaction for 5 hours at 50° C. Thus, a ketimine compound was prepared. The ketimine compound had an amine value of 423 mgKOH/g.

### Preparation of Toner

A resin solution 20 was prepared by mixing and agitating 100 parts of the resin 4, 30 parts of the polyester prepolymer, and 80 parts of ethyl acetate in a reaction vessel.

Further, 5 parts of a carnauba wax (having a molecular weight of 1,800, an acid value of 2.7 mgKOH/g, and a penetration of 1.7 mm (at 40° C.)) and 5 parts of the master batch (b) were added to the resin solution 20. The resulting mixture was then subjected to a dispersion treatment using a bead mill (ULTRAVISCOMILL (trademark) from Aimex Co., Ltd.) filled with 80% by volume of zirconia beads having a diameter of 0.5 mm, at a liquid feeding speed of 1 kg/hour and a disc peripheral speed of 6 m/sec. This dispersing operation was repeated 3 times (3 passes).

Further, 2.5 parts of the ketimine compound were added to the mixture. Thus, a toner components liquid was prepared.

While agitating 150 parts of the aqueous medium (b) in a vessel at a revolution of 12,000 rpm using a TK HOMOMIXER (from PRIMIX Corporation), 100 parts of the above-prepared toner components liquid were added and mixed for 10 minutes. Thus, an emulsion slurry (b) was prepared.

A flask equipped with a stirrer and a thermometer was charged with 100 parts of the emulsion slurry (b). The emulsion slurry (b) was agitated for 10 hours at 30° C. at a peripheral speed of 20 m/min so that the organic solvents were removed therefrom. Thus, a dispersion slurry (b) was prepared.

Next, 100 parts of the dispersion slurry (b) was filtered under reduced pressures to obtain a wet cake (i). The wet cake (i) was then mixed with 100 parts of ion-exchange water using a TK HOMOMIXER for 10 minutes at a revolution of 12,000 rpm, followed by filtration, thus obtaining a wet cake (ii).

The wet cake (ii) was mixed with 300 parts of ion-exchange water using a TK HOMOMIXER for 10 minutes at a revolution of 12,000 rpm, followed by filtration. This operation was repeated twice, thus obtaining a wet cake (iii). The wet cake (iii) was mixed with 20 parts of a 10% aqueous solution of sodium hydroxide using a TK HOMOMIXER for 30 minutes at a revolution of 12,000 rpm, followed by filtration under reduced pressures, thus obtaining a wet cake (iv). The wet cake (iv) was mixed with 300 parts of ion-exchange water using a TK HOMOMIXER for 10 minutes at a revolution of 12,000 rpm, followed by filtration, thus obtaining a wet cake (v). The wet cake (v) was mixed with 300 parts of ion-exchange water using a TK HOMOMIXER for 10 minutes at a revolution of 12,000 rpm, followed by filtration. This operation was repeated twice, thus obtaining a wet cake (vi). The wet cake (vi) was mixed with 20 parts of a 10% hydrochloric acid using a TK HOMOMIXER for 10 minutes at a revolution of 12,000 rpm. Thereafter, a 5% methanol solution of a fluorine-containing quaternary ammonium salt (FTERGENT F-310 from Neos Company Limited) was added so that the resulting mixture was including 0.1 parts of the fluorine-containing quaternary ammonium salt based on 100 parts of the solid components. The mixture was further agitated for 10 minutes, followed by filtration, thus obtaining a wet cake (vii). The wet cake (vii) was mixed with 300 parts of ion-exchange water using a TK HOMOMIXER for 10 minutes at a revolution of 12,000 rpm, followed by filtration. This operation was repeated twice, thus obtaining a wet cake (viii).

The wet cake (viii) was dried by a circulating drier for 36 hours at 40° C., and filtered with a mesh having openings of 75 μm. Thus, mother toner particles 20 were prepared. The succeeding procedures were the same as Example 14. Thus, a toner 20 was prepared.

### Example 21

### Preparation of Toner 21

The procedure for preparing the toner 20 in Example 20 was repeated except that the resin 4 was replaced with the resin 5. Thus, toner 21 was prepared.

### Example 22

### Preparation of Toner 22

The procedure for preparing the toner 20 in Example 20 is repeated except that the resin 4 is replaced with the resin 6. Thus, toner 22 was prepared.

The above-prepared toners were subjected to evaluations of fixability and heat-resistant storage stability as follows. The evaluation results are shown in Table 7.

### Evaluation of Fixability

An electrophotographic copier (MF-200 from Ricoh Co., Ltd.) employing a TEFLON fixing roller was modified so that the temperature of the fixing roller was variable. Each of the toners was mounted on the copier, and solid images having 0.85±0.1 mg/cm² were formed on sheets of a normal paper TYPE 6200 (from Ricoh Co., Ltd.) and a thick paper <135> (from NBS Ricoh) while varying the temperature of the fixing roller to determine the maximum and minimum fixable temperatures. The maximum fixable temperature is a temperature above which hot offset occurs on the normal paper. The minimum fixable temperature is a temperature below which the residual rate of image density after rubbing the solid image falls below 70% on the thick paper. The evaluation results were graded into 4 levels as follows. Grades A to C can be put into practical use.

### Maximum Fixable Temperature Grades

A: not less than 190° C.

B: not less than 180° C. and less than 190° C.

C: not less than 170° C. and less than 180° C.

D: less than 170° C.

### Minimum Fixable Temperature Grades

A: less than 135° C.

B: not less than 135° C. and less than 145° C.

C: not less than 145° C. and less than 155° C.

D: not less than 155° C.

### Evaluation of Heat-Resistant Storage Stability

Each of the toners in an amount of 4 g was contained in an open-system cylindrical container having a diameter of 5 cm and a height of 2 cm, and left for 72 hours at 45° C. and 65% RH. After slightly shaking the container, the toner was visually observed to determine whether toner particles had aggregated or not. The evaluation results were graded into 4 levels as follows. Grades A to C can be put into practical use.

A: No toner aggregation was observed.

B: Toner aggregations in an amount of 1 to 2 were observed.

C: Toner aggregations in an amount of 3 to 5 were observed.

D: Toner aggregations in an amount of 6 or more were observed.

TABLE 7

| | | | Heat- | | |
|---|---|---|---|---|---|
| | | | Resistant | Minimum | Maximum |
| | | | Storage | Fixable | Fixable |
| | Toner | Resin | Stability | Temperature | Temperature |
| Example 1 | 1 | 1 | B | B | A |
| Example 2 | 2 | 2 | B | B | A |
| Example 3 | 3 | 3 | B | B | A |
| Example 4 | 4 | 4 | A | A | A |
| Example 5 | 5 | 5 | A | B | A |
| Example 6 | 6 | 6 | A | A | A |
| Example 7 | 7 | 7 | A | A | A |
| Example 8 | 8 | 8 | A | A | A |
| Example 9 | 9 | 9 | A | A | A |
| Example 10 | 10 | 10 | A | A | A |
| Example 11 | 11 | 11 | A | A | A |
| Example 12 | 12 | 12 | A | A | A |
| Example 13 | 13 | 13 | A | A | A |
| Example 14 | 14 | 4 | A | A | A |
| Example 15 | 15 | 5 | A | B | A |
| Example 16 | 16 | 6 | A | A | A |
| Example 17 | 17 | 4 | A | A | A |
| Example 18 | 18 | 5 | A | B | A |
| Example 19 | 19 | 6 | A | A | A |
| Example 20 | 20 | 4 | A | A | A |
| Example 21 | 21 | 5 | A | B | A |
| Example 22 | 22 | 6 | A | A | A |
| Comparative | 23 | 14 | D | B | B |
| Example 1 | | | | | |
| Comparative | 24 | 15 | D | D | B |
| Example 2 | | | | | |
| Comparative | 25 | 16 | D | B | D |
| Example 3 | | | | | |
| Comparative | 26 | 17 | D | C | C |
| Example 4 | | | | | |

Additional modifications and variations of the present invention are possible in light of the above teachings. It is therefore to be understood that within the scope of the appended claims the invention may be practiced other than as specifically described herein.

What is claimed is:

1. A resin for use in toner, comprising:
a polyhydroxycarboxylic acid skeleton in an amount of 50 to 80% by mass,
the resin being soluble in organic solvents and having a glass transition temperature of 60° C. or more.

2. The resin according to claim 1, further comprising a rigid moiety obtained from condensation of an aromatic dicarboxylic acid with an aliphatic diol.

3. The resin according to claim 2, the rigid moiety having the following formula (1): 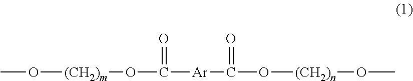
wherein each of m and n independently represents an integer of 2 to 10 and Ar represents an aromatic group.

4. The resin according to claim 1, the resin having a number average molecular weight of 30,000 or less.

5. The resin according to claim 1, the polyhydroxycarboxylic acid skeleton being obtained by polymerizing at least one hydroxycarboxylic acid having 2 to 6 carbon atoms.

6. The resin according to claim 1, the polyhydroxycarboxylic acid skeleton being obtained by polymerizing at least one lactic acid.

7. The resin according to claim 1, the polyhydroxycarboxylic acid skeleton being obtained by ring-opening polymerizing a lactide.

8. The resin according to claim 1, the polyhydroxycarboxylic acid skeleton being obtained by ring-opening polymerizing a mixture of an L-lactide and a D-lactide.

9. The resin according to claim 1, the polyhydroxycarboxylic acid skeleton being a polylactic acid skeleton.

10. The resin according to claim 9, the resin having an optical purity X (%) of 80% or less, the optical purity being represented by the following equation (I):
X (%)=|X(L-form)−X(D-form)| (I)
wherein X(L-form) represents a ratio (%) of an L-form lactic acid monomer component and X(D-form) represents a ratio (%) of a D-form lactic acid monomer component.

11. A toner, comprising the resin according to claim 1.

12. A developer, comprising the toner according to claim 11.
